(19) United States
(12) Patent Application Publication
(10) Pub. No.: US 2004/0162066 A1
(43) Pub. Date: Aug. 19, 2004

(54) Isolation and remediation of a communication device

(76) Inventors: Ravi Kuchibhotla, Gurnee, IL (US); Niels Peter Skov Andersen, Roskilde (DK)

Correspondence Address: MOTOROLA INC, 600 NORTH US HIGHWAY 45, ROOM AS437, LIBERTYVILLE, IL, 60048-5343, US

(21) Appl. No.: 10/779,756

(22) Filed: Feb. 17, 2004

Related U.S. Application Data
(62) Division of application No. 10/005,775, filed on Nov. 2, 2001, now Pat. No. 6,715,202.

(51) Int. Cl. H04Q 7/20

(52) U.S. Cl. 455/423; 455/435.1

(57) ABSTRACT

A method (200) and an apparatus (400) for a communication network (102) for isolating and remediating a communication device (114) are provided. The communication network receives a call from the communication device (204), determines whether a characteristic of the call is undesirable (206), terminates the call (214) upon determining the characteristic of the call is undesirable, disables the communication device from initiating a new call (216), and de-registering the communication device (218). Upon determining the characteristic of the call is undesirable, the communication network may re-direct the call to a remediation center (518) where the communication device can be remedied.

### FIELD OF THE INVENTION

The present invention generally relates to a communication network, and more specifically to isolation and remediation of a communication device in the communication network.

### BACKGROUND OF THE INVENTION

With increasing usage of data services in systems such as General Packet Radio Service (“GPRS”) system and Universal Mobile Telecommunications System (“UMTS”) in the near future, there is an increasing threat of viruses being downloaded into user equipment (“UE”) such as cellular telephones, wireless capable Personal Digital Assistants (“PDAs”), computers, and other similar electronic equipment. Java downloads, for example, pose a significant threat to both users and operators in terms of lost revenue and loss of service. One virus, which can potentially limit system operations and cause severe damages, is a virus that leads to a large quantity of junk data usage on the radio communication network causing high expense to end users and wasteful use of radio resources for the operators. Such damages can occur without a user of an infected cellular telephone actively using the infected cellular telephone, or when the user is actively using a different application, such as a voice call, of the infected cellular telephone.

One potential solution to mitigate such a threat is to have a network recognize the activation of a virus and tear down a network connection, such as an interface between Radio Network Controller (“RNC”) and Core Network (“CN”), namely the interface (“Iu”) connection, which then triggers a teardown of the radio connection such as the Radio Resource Control (“RRC”) connection, if there is no voice activity. Tearing down the network connection and thereafter tearing down the radio connection, however, may not completely resolve the problem because the virus could cause a re-initiation of the radio connection establishment, and subsequently a re-initiation of the network connection, which would then cause significant impact to the network load.

Today when a UE performs a Location Update, or similarly Routing Area Update, which may be performed periodically, upon change of location, or based upon initial attachment in case of Location Update, the network checks the subscription, and may reject the UE using certain cause values, which are described in the technical specification document, 3GPP TS 24.008 V6.3.0 (2003-12), entitled “3rd Generation Partnership Project; Technical Specification Group Core Network; Mobile radio interface Layer 3 specification; Core network protocols; Stage 3 (Release 6)” (“3GPP TS 24.008 V6.3.0”) published by the 3rd Generation Partnership Project (“3GPP”), December 2003, which is herein incorporated by reference. Those cause values are #2 for International Mobile Subscriber Identity (“IMSI”) unknown in Home Location Register (“HLR”), #3 for an illegal Mobile Station (“MS”), and #6 for an illegal Mobile Equipment (“ME”). However, the network is capable of rejecting a UE only in response to a Location Update transmitted by the UE, and the network remains vulnerable and exposed to a threat of a virus attack for a time period between Location Updates.

### BRIEF DESCRIPTION OF THE DRAWINGS

FIG. 1 is an exemplary block diagram of an environment where an embodiment in accordance with the present invention may be practiced;

FIG. 2 is an exemplary flowchart illustrating a method in a communication network for isolating a communication device in accordance with the present invention;

FIG. 3 is an exemplary flowchart further describing disabling of the communication device from initiating a new call in accordance with the present invention;

FIG. 4 is an exemplary block diagram of a communication network configured to isolate a communication device in accordance with the present invention;

FIG. 5 is an exemplary flowchart illustrating a method in a communication network for remediating a communication device in accordance with the present invention;

FIG. 6 is an exemplary flowchart illustrating a method in a communication device for remedying the communication device in accordance with the present invention; and

FIG. 7 is an exemplary block diagram of a communication device configured to remedy the communication device in accordance with the present invention.

### DETAILED DESCRIPTION OF THE PREFERRED EMBODIMENTS

The present invention provides a method and apparatus for isolating a communication device that is determined to be operating in an undesirable way in a communication network. The present invention further provides a method and apparatus for the communication network to remediate the isolated communication device. Upon receiving a call from a communication device, the communication network determines a characteristic of the call from the communication device, and determines whether the characteristic is undesirable. For example, the communication network may determine that the call includes an attachment that is known to be or to contain a virus, or that the communication device repeatedly initiates a call in a recognizable pattern, suggesting that the communication device is controlled by a virus residing within. Once the communication network determines the characteristic of the call is undesirable, the communication network isolates the communication device by disabling the communication device from initiating a new call, and terminates the call in progress. However, the communication network may allow the isolated communication device to initiate an emergency call. The communication network may then connect the communication device directly to a remediation center where the communication device can be remedied.

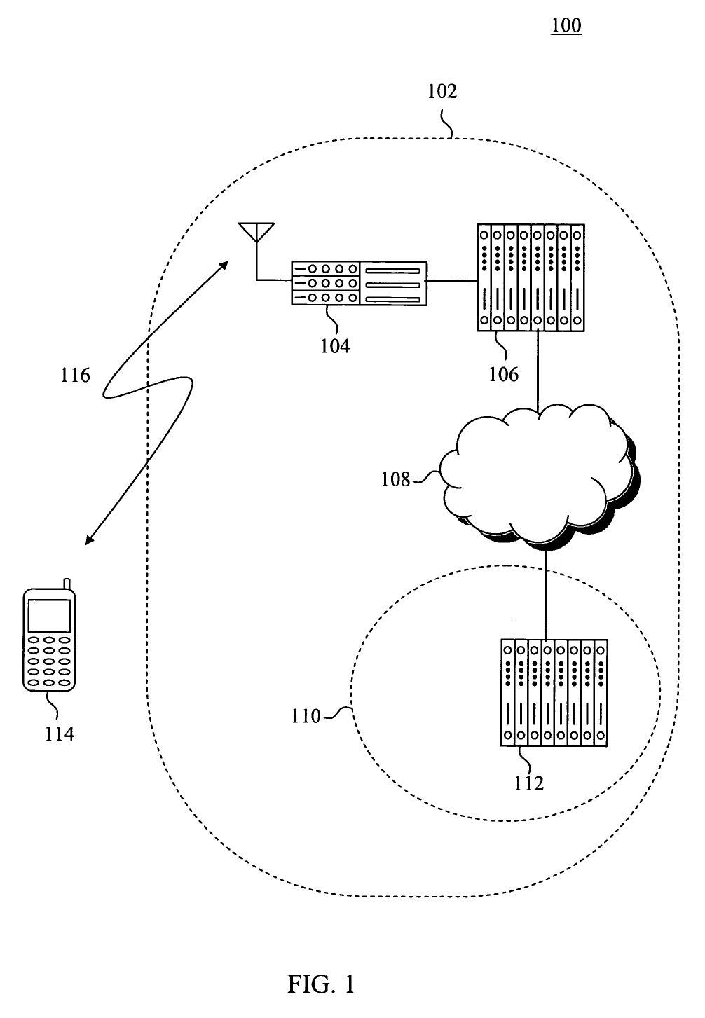

FIG. 1 is an exemplary block diagram 100 of an environment where an embodiment in accordance with the present invention may be practiced. A communication network 102 comprises various components such as a base station 104 capable of communicating with communication devices, a server 106 which may contain registration information of the communication devices, and other components, which are shown as a group 108. The communication network 102 may further comprise a remediation center 110, which includes a remediation server 112. The communication network 102 is capable of communicating with a communication device 114 through the base station 104. In FIG. 1, the communication method used is shown as wireless communication 116 between the communication network 102 and the communication device 114 as an example, but other communication methods such as, but not limited to, wired connection and optical connection may be used. Although the communication device 114 is shown as a wireless communication device in FIG. 1, the communication device 114 may be a Personal Digital Assistant (“PDA”), a computer, or any other electronic device capable of communicating with the communication network 102.

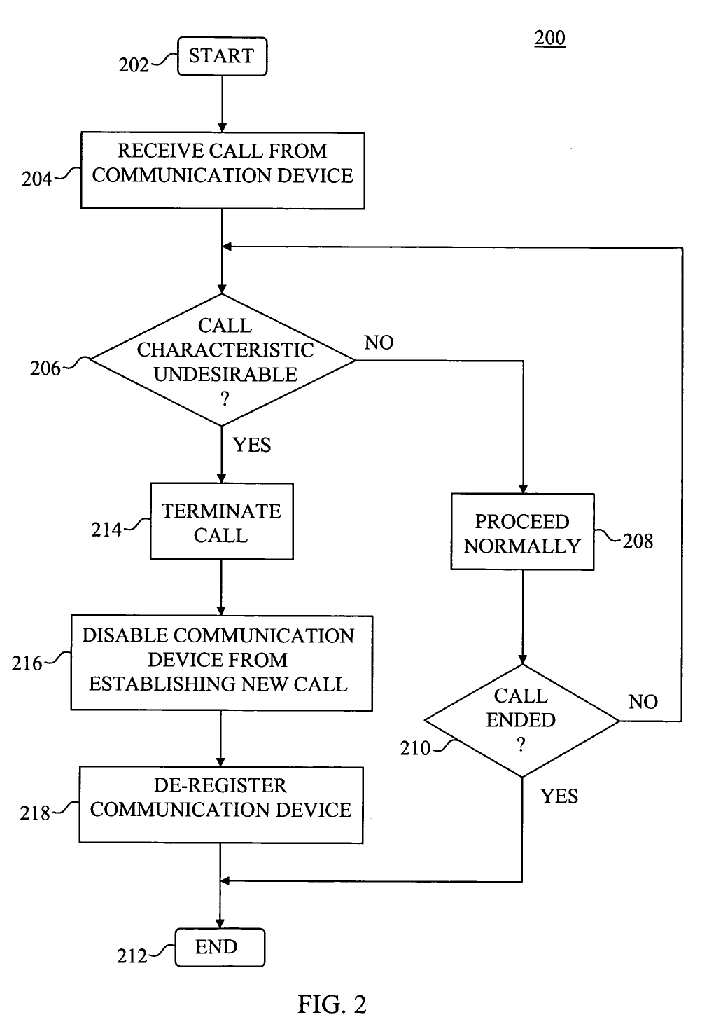

FIG. 2 is an exemplary flowchart 200 illustrating a method in the communication network 102 for isolating the communication device 114 in accordance with the present invention. The process begins in block 202, and in block 204, the communication network 102 receives a call from the communication device 114. The call can be a call in either a circuit switched network or a packet switched network. The communication network 102 then determines in block 206 whether the call received has one or more undesirable characteristics. To determine whether a characteristic of the call is undesirable, the communication network 102 may evaluate several aspects of the call from the communication device 114. For example, the communication network 102 may evaluate a pattern of the call as a characteristic and determine that a new call is initiated by the communication device 114 every few seconds, which has a pattern of a communication device infected with a known virus. The communication network 102 may also compare the characteristic of the call with a predetermined undesirable characteristic, for example by recognizing an attached file or data being transmitted from the communication device 114 as one of several files known to contain viruses. Further, the communication network 102 may monitor the call throughout the duration of the call, and may determine the characteristic of the call to be undesirable any time during the call. For example, the communication device 114 may initially make a call that has no undesirable characteristics, however, the communication device 114 may later attach and transmit a virus file while the call is active. If, upon initially receiving the call in block 204, the communication network 102 determines that the characteristic of the call is not undesirable in block 206, the communication network 102 begins to process the call normally in block 208. However, the communication network 102 continues to monitor the call throughout the duration of the call for an undesirable characteristic until the call is determined to have ended in block 210. The process then terminates in block 212.

If the communication network 102 determines that a characteristic of the call is undesirable in block 206, for example, the communication network 102 determines that the communication device 114 is suspected of virus infection, then the communication network 102 terminates the call in block 214. The termination of the call does not necessarily mean that the communication between the communication network 102 and the communication device 114 is completely severed. The call may comprise several call sessions, such as a voice call and data transfer sessions, and only one of those sessions may be found to have an undesirable characteristic and be terminated. The communication network 102 then disables the communication device 114 from establishing a new call in block 216. If the call comprises only one call session, then the communication network 102 may disable the communication device 114 from establishing a new call before terminating the call. The communication network 102 may further de-register the communication device 114 from its register in block 218, and the process terminates in block 212. The de-registration may be accomplished by maintaining a de-registration list, which includes an identification, such as the IMSI, International Mobile Equipment Identity (“IMEI”), and Subscriber Identification Module (“SIM”), of the communication device 114. However, if the communication device 114, which is now de-registered and is disabled from establishing a new call, attempts to initiate a call, the communication network 102 may allow the call to complete only to a predetermined limited set of destinations such as an emergency service provider.

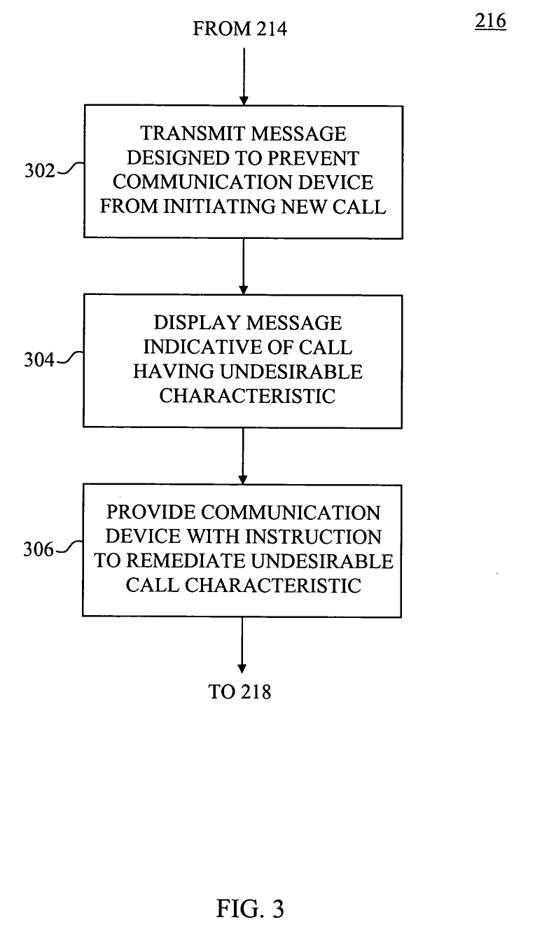

FIG. 3 is an exemplary flowchart further describing block 216 of disabling the communication device 114 from establishing a new call in accordance with the present invention. Upon determining a characteristic of the call is undesirable in block 206, the communication network 102 may transmit a message, or a data file, designed to disable the communication device 114 from establishing a new call in block 302. The message may also include a notification indicative of the characteristic of the call being undesirable such as a cause value similar to the cause values described in Section 4.4.4.7 “Location updating not accepted by the network” of 3GPP TS 24.008 V6.3.0, or a notification indicative of the communication device 114 suspected of virus infection by displaying a short message such as “VIRUS INFECTION SUSPECTED. CALL TERMINATED” in block 304. The message may further include an instruction to remediate the communication device 114 as shown in block 306. The instruction may include a step-by-step how-to, or a phone number and/or an Internet Protocol (“IP”) address in the World Wide Web for the remediation center where a remediation program can be downloaded or a remediation can be performed. The phone number or IP address of the remediation center can be included as one of the predetermined limited set of destinations that the communication device 114 is allowed to establish communication with. The remediation center address may also be preloaded into an internal memory of the communication device 114, or a SIM-like removable module, and an instruction for how to access the remediation center address may be provided. Following de-registration, as a part of the de-registration process or at a subsequent time, the communication device 114 may be routed to the remediation center indicated by the preloaded address. The remediation center may also be located within the communication device 114. For example, the remediation center may be reached by accessing a specific address in an internal memory of the communication device 14, or a SIM-like removable module, where a remediation program is preloaded. The message may include a mechanism designed to remediate a cause of the undesirable characteristic of the call such as an executable virus disinfection file. Alternatively, the communication network 102 may redirect the call to a remediation center, which is designed to remediate the communication device 114. A short message such as “VIRUS INFECTION SUSPECTED. CONNECTING TO REMEDIATION CENTER” may be displayed on the communication device 114 to notify that the call is being redirected.

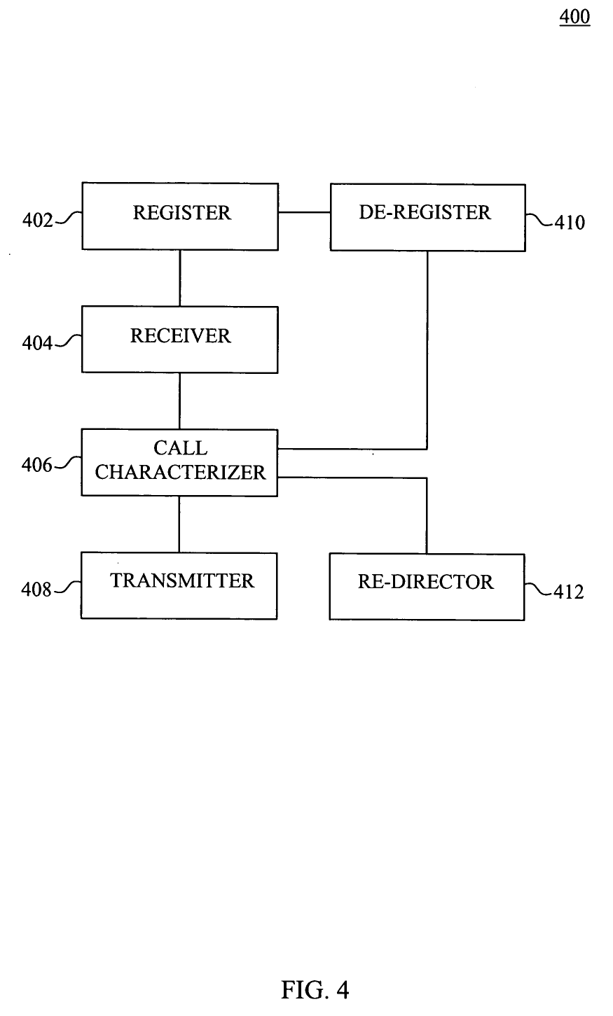

FIG. 4 is an exemplary block diagram of a communication network 400 configured to isolate a communication device in accordance with the present invention. The communication network 400 comprises a register 402, which is configured to register an identification of a communication device authorized to access the communication network, and a receiver 404, which is coupled to the register 402 and is configured to receive a call from the communication device. A call characterizer 406 is coupled to the receiver 404 and is configured to determine whether at least one characteristic of the call received from the communication device is undesirable and indicative of a virus infection. To determine whether a characteristic of the call is undesirable, the call characterizer 406 may evaluate a call pattern from the communication device such as rapid and numerous calls indicative of a virus-infected communication device. The call characterizer 406 may also compare the call with a predetermined undesirable characteristic, for example by recognizing an attached file or data being transmitted from the communication device as one of several files known to contain viruses. The call characterizer 406 may further be configured to monitor the call throughout the duration of the call, such that the call characterizer 406 can determine a characteristic of the call to be undesirable any time during the call.

A transmitter 408 is coupled to the call characterizer 406 and is configured to transmit a disabling message to the communication device if the call characterizer 406 determines that a characteristic of the call is undesirable. The disabling message is designed t o disable the communication device such that the communication device is prevented from establishing a new call. However, the disabling message might not disable the communication device from making an emergency call, and might allow the communication device to initiate a call to a remediation center where the communication device can be remedied. The transmitter 408 may further be configured to transmit a notification indicative of the call having an undesirable characteristic if the call characterizer determines a characteristic of the call is undesirable. The notification may include an instruction to remediate the communication device, or may include a mechanism, such as a virus disinfection program, designed to remediate the communication device. The instruction may include a step-by-step how-to, or a phone number and/or an Internet Protocol (“IP”) address in the World Wide Web for the remediation center where a remediation program can be downloaded or a remediation can be performed. The remediation center address may also be preloaded into an internal memory of the communication device114, or a SIM-like removable module, and an instruction for how to access the remediation center address may be provided. The instruction may also include autonomous triggering of a connection to a remediation center pointed to by the preloaded address in the SIM of the communication device, at any time during or following the de-registering of the communication device.

The register 402 may further be configured to de-register the identification of the communication device if the call characterizer determines that a characteristic of the call from the communication device is undesirable. Alternatively, the communication network 400 may further comprise a de-registration register 410, which is coupled to both the call characterizer 406 and to the register 402, configured to maintain the identification of the communication device if the call characterizer 406 determines that a characteristic of the call is undesirable.

The communication network 400 may further comprise a call re-director 412, which is coupled to the call characterizer 406. The call re-director 412 is configured to re-direct the call to a remediation center where a cause of the communication device can be remedied, if the call characterizer 406 determines that the call has an undesirable characteristic.

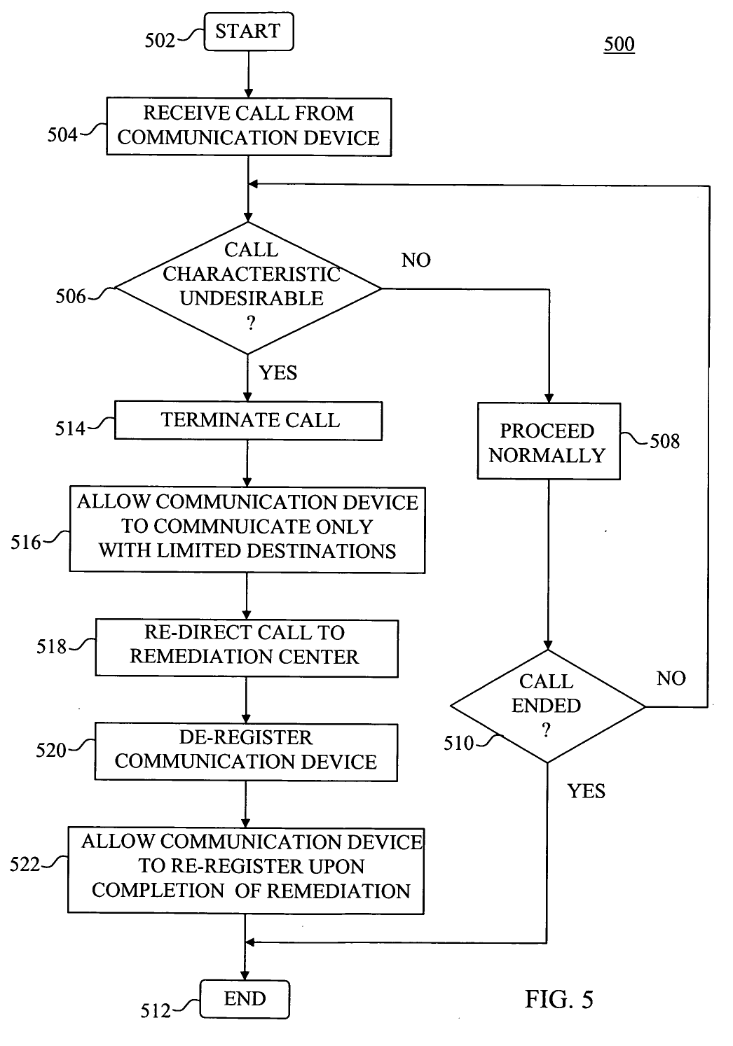

FIG. 5 is an exemplary flowchart 500 illustrating a method in a communication network 102 for remediating a communication device 114 in accordance with the present invention. The process begins in block 502, and the communication network 102 receives a call from the communication device 114 in block 504. The communication network 102 then determines whether the call received has one or more undesirable characteristics in block 506. To determine whether a characteristic of the call is undesirable, the communication network 102 may evaluate various aspects of the call as previously described. If, upon initially receiving the call in block 504, the communication network 102 determines that a characteristic of the call is not undesirable in block 506, the communication network 102 begins to process the call normally in block 508. However, the communication network 102 continues to monitor the call throughout the duration of the call for an undesirable characteristic until the call is determined to have ended in block 510. The process then terminates in block 512. If the communication network 102 determines that a characteristic of the call is undesirable in block 506, then the communication network 102 terminates the call in block 514, and allows the communication device 114 to establish communication only with a predetermined limited set of destinations such as an emergency service provider and a remediation center in block 516. As previously described, the termination of the call means that one or more of the plurality of call sessions comprising the call may be terminated. Upon determining a characteristic of the call is undesirable in block 506, the communication network 102 may transmit a message indicative of the call having an undesirable characteristic to the communication device 114. The message may also include a notification that the call will be redirected to a remediation center. The communication network 102 then redirects the call in block 518 to the remediation center where the communication device can be remedied, and de-registers the communication device 114 from the communication network 102 in block 520. The redirection of the call to the remediation center may be accomplished by providing a step-by-step how-to, or a phone number and/or an IP address in the World Wide Web for the remediation center where a remediation program can be downloaded or a remediation can be performed. The IP address can be preloading into the SIM of the communication device 114. The remediation center address may also be preloaded into an internal memory of the communication device 114, or a SIM-like removable module, and an instruction for how to access the remediation center address may be provided. As previously described, the remediation center may also be located within the communication device 114. Upon completion of remediation, the communication network 102 allows the communication device 114 to re-register with the communication network 102 in block 522, and the process terminates in block 512. The communication network 102 may additionally transmit a notification of the completion of remediation to the communication device 114 upon completing the remediation process.

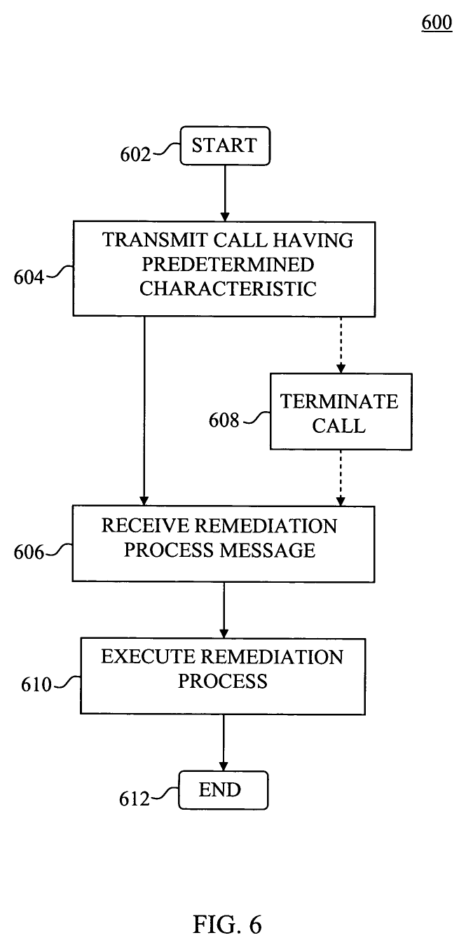

FIG. 6 is an exemplary flowchart 600 illustrating a method in a communication device 114 for remedying the communication device 114 in accordance with the present invention. The process begins in block 602, and the communication device 114 transmits a call having one or more of predetermined characteristics in block 604. The call may comprise a plurality of call sessions, and any one of the plurality of call sessions may have one or more of the predetermined characteristics associated with it. As previously described, the communication network 102 can evaluate various aspects of the call and determine whether the call has one or more undesirable characteristics. In response to transmitting the call having one or more of predetermined characteristics in block 604, the communication device 114 receives a remediation process message indicative of a remediation process designed to remove a cause of the predetermined characteristics in block 606.

The remediation process message includes a remediation process designed to remedy the communication device 114 such that the communication device 114 is able to transmit without having the predetermined characteristic or characteristics. The remediation process message may further include elements such as, but not limited to,

a notification of the transmission of the call having a predetermined undesirable characteristic, a cause value corresponding to the predetermined characteristic of the call, a notification of the remediation process, an instruction to connect to a remediation center, and a remediation program designed to remedy a cause of the predetermined characteristic. The call may be terminated by terminating one or more of call sessions associated with predetermined characteristics before receiving the remediation process message as shown with dotted arrows in block 608. In block 610, the communication device 114 executes the remediation process. The remediation process execution may be accomplished in various ways such as, but not limited to, by executing the remediation program included in the remediation process message, by re-directing the call to a remediation center, which is designed to remedy a cause of the predetermined characteristic or characteristics, or by allowing the communication device 114 to establish communication only with a predetermined limited set of destinations such as an emergency service provider and the remediation center. The redirection of the call to the remediation center may be accomplished by providing a step-by-step how-to, or a phone number and/or an IP address in the World Wide Web for the remediation center where a remediation program can be downloaded or a remediation can be performed. As previously described, the remediation center may be located within the communication device 114, and the IP address of the remediation center can be preloaded in the SIM of the communication device 114 and be accessed. The process then ends in block 612.

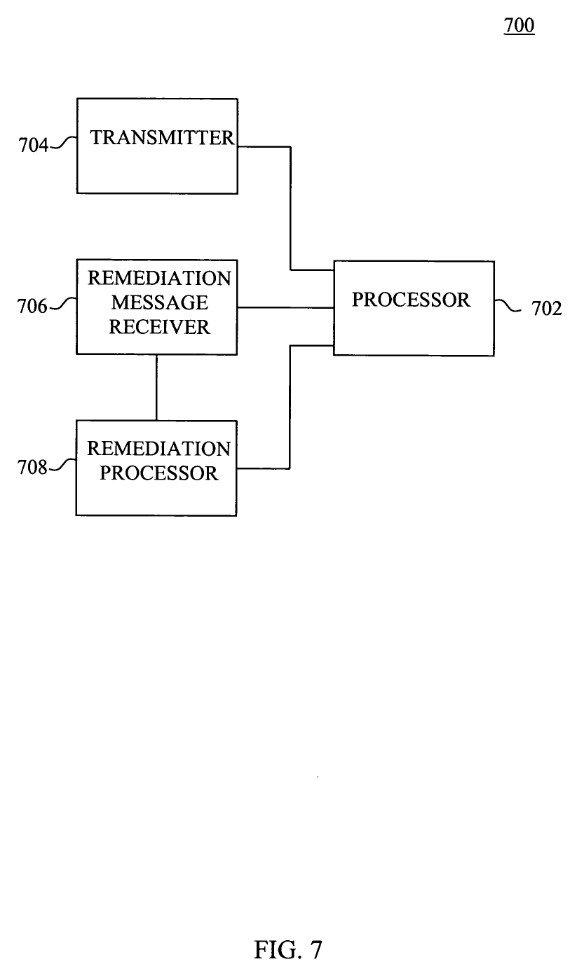

FIG. 7 is an exemplary block diagram 700 of a communication device 114 configured to remedy the communication device 114 in accordance with the present invention. The communication device 114 comprises various elements. A processor 702 is configured to provide a plurality of characteristics to a call. A transmitter 704 is coupled to the processor 702, and is configured to transmit a call having one or more of characteristics of the plurality of the characteristics provided by the processor 702. A remediation message receiver 706 is coupled to the processor 702, and is configured to receive a remediation message if the characteristic of the transmitted call is determined to be one of several predetermined characteristics, which are defined to be undesirable. A remediation processor 708 is coupled to the remediation message receiver 706 and to the processor 702, and is configured to execute an instruction according to the remediation message, which is designed to remedy the communication device 114 such that the communication device 114 is able to transmit subsequent calls without having the undesirable predetermined characteristic. The remediation message may include various elements such as, but not limited to, an acknowledgement of the transmission of the call having a predetermined characteristic, a cause value corresponding to the predetermined characteristic of the call; a remediation program designed to remedy the communication device 114, and a re-direction of the call to a remediation center, which is designed to remedy the communication device 114.

While preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method in a communication network for isolating a communication device, the method comprising:
receiving a call from the communication device;
determining whether a characteristic of the call is undesirable;
terminating the call;
disabling the communication device from establishing a new call upon determining the characteristic of the call is undesirable; and
de-registering the communication device.

2. The method of claim 1, wherein determining whether a characteristic of the call is undesirable includes monitoring the call for the duration of the call.

3. The method of claim 1, wherein determining whether the characteristic of the call is undesirable includes at least one of:
evaluating a pattern of the call from the communication device; and
comparing the characteristic of the call to a predetermined undesirable characteristic.

4. The method of claim 1, wherein:
the call comprises a plurality of call sessions, and
terminating the call includes terminating one call session of the plurality of call sessions.

5. The method of claim 1, further comprising:
transmitting a message indicative of the call having an undesirable characteristic to the communication device upon determining the characteristic of the call is undesirable.

6. The method of claim 5, wherein the message includes at least one of:
a cause value indicative of the undesirable characteristic of the call;
an instruction to remediate the communication device; and
a mechanism designed to remediate the communication device.

7. The method of claim 1, wherein disabling the communication device from initiating a new call includes transmitting a disabling message to the communication device.

8. The method of claim 1, wherein de-registering the communication device includes maintaining a de-registration list having an identification of the communication device.

9. The method of claim 1, further comprising:
redirecting the call to a remediation center,
wherein the remediation center is designed to remediate the communication device.

10. The method of claim 9, wherein redirecting the call to the remediation center by at least one of:
providing an instruction to connect to the remediation center; and
establishing a communication between the communication device and the remediation center.

11. The method of claim 1, further comprising:
restricting the de-registered communication device in establishing communication to a predetermined limited set of destinations upon determining the characteristic of the call is undesirable.

12. The method of claim 11, wherein the predetermined limited set of destinations includes at least one of:
an emergency service provider, and
a remediation center,
wherein the remediation center is designed to remediate the communication device.

13. A communication network configured to isolate a communication device, the network comprising:
a register configured to register an identification of a communication device authorized to access the communication network;
a receiver coupled to the register, the receiver configured to receive a call from the communication device;
a call characterizer coupled to the receiver, the call characterizer configured to determine whether a characteristic of the call is undesirable; and
a transmitter coupled to the call characterizer, the transmitter configured to transmit a disabling message to the communication device if the call characterizer determines the characteristic of the call is undesirable,
wherein the disabling message is configured to prevent the communication device from establishing a new call.

14. The communication network of claim 13, wherein the register is further configured to de-register the identification of the communication device if the call characterizer determines the characteristic of the call is undesirable.

15. The communication network of claim 13, further comprising:
a de-registration register coupled to the call characterizer and to the register, the de-registration register configured to maintain the identification of the communication device if the call characterizer determines the characteristic of the call is undesirable.

16. The communication network of claim 13, further comprising:
a call re-director coupled to the call characterizer, the call re-director configured to re-direct the call to a remediation center if the call characterizer determines the characteristic of the call is undesirable,
wherein the remediation center is configured to remediate the communication device.

17. The communication network of claim 13, wherein the call characterizer is further configured to evaluate a pattern of the call from the communication device.

18. The communication network of claim 13, wherein the call characterizer is further configured to compare the characteristic of the call to a predetermined undesirable characteristic.

19. The communication network of claim 13, wherein the transmitter is further configured to transmit a notification indicative of the call having an undesirable characteristic if the call characterizer determines the characteristic of the call is undesirable.

20. The communication network of claim 19, wherein the notification includes at least one of:
an instruction to remediate the communication device; and
a mechanism designed for the communication device to remediate a cause of the undesirable characteristic of the call.

21. The communication network of claim 13, wherein the disabling message is further configured to allow the communication device to initiate a call if the call is directed to one of a predetermined limited set of destinations.

22. The communication network of claim 21, wherein the predetermined limited set of destinations includes at least one of:
an emergency service provider; and
a remediation center,
wherein the remediation center is configured to remediate the communication device.

23. A method in a communication network for remediating a communication device, the method comprising:
receiving a call from the communication device;
determining whether a characteristic of the call is undesirable;
terminating the call;
redirecting the call to a remediation center upon determining the characteristic of the call is undesirable;
de-registering the communication device; and
allowing the communication device to re-register upon completion of remediation,
wherein the remediation center is designed to remediate the communication device.

24. The method of claim 23, wherein:
the call comprises a plurality of call sessions, and
terminating the call by terminating one call session of the plurality of call sessions.

25. The method of claim 23, further comprising:
restricting the communication device in establishing communication to a predetermined limited set of destinations upon determining the characteristic of the call is undesirable.

26. The method of claim 25, wherein the predetermined limited set of destinations include at least one of:
an emergency service provider; and
the remediation center.

27. The method of claim 23, wherein redirecting the call to the remediation center by at least one of:
providing an instruction to connect to the remediation center; and
establishing a communication between the communication device and the remediation center.

28. The method of claim 23, further comprising:
transmitting a message to the communication device upon determining the characteristic of the call is undesirable, wherein the message includes at least one of:
an indication of the call having an undesirable characteristic; and
a notification of the call being redirected to the remediation center.

29. The method of claim 23, further comprising:
transmitting a notification of completion of remediation to the communication device upon completion of remediation of the communication device.

30. A method in a communication device for remedying the communication device, the method comprising:
transmitting a call having a predetermined characteristic;
receiving a remediation process message indicative of a remediation process designed to remedy the communication device in response to transmitting the call having the predetermined characteristic; and
executing the remediation process.

31. The method of claim 30, further comprising:
terminating the call in response to transmitting the call having the predetermined characteristic.

32. The method of claim 31, wherein:
the call comprises a plurality of call sessions, and
terminating the call by terminating one call session of the plurality of call sessions.

33. The method of claim 30, wherein the remediation process message includes at least one of:
a notification of the transmission of the call having the predetermined characteristic;
a cause value corresponding to the predetermined characteristic of the call;
a notification of the remediation process;
an instruction to connect to a remediation center; and
a remediation program designed to remedy a cause of the predetermined characteristic.

34. The method of claim 33, wherein executing the remediation process by at least one of:
executing the remediation program included in the remediation process message;
re-directing the call to a remediation center, wherein the remediation center is designed to remedy the communication device;
restricting establishing communication to a predetermined limited set of destinations.

35. The method of claim 34, wherein the predetermined limited set of destinations includes at least one of:
an emergency service center, and
the remediation center.

36. A communication device configured to remedy the communication device, the communication device comprising:
a processor configured to provided a plurality of characteristics to a call;
a transmitter coupled to the processor, the transmitter configured to transmit a call having a characteristic of the plurality of the characteristics provided by the processor;
a remediation message receiver coupled to the processor, the remediation message receiver configured to receive a remediation message if the transmitted call is determined to have a predetermined characteristic; and
a remediation processor coupled to the remediation message receiver and to the processor, the remediation processor configured to execute an instruction according to the remediation message,
wherein the remediation message is designed to enable the communication device to transmit a subsequent call without having the predetermined characteristic.

37. The communication device of claim 36, wherein the remediation message includes at least one of:
an acknowledgement of the transmission of the call having the predetermined characteristic;
a cause value corresponding to the predetermined characteristic of the call;
a remediation program designed to remedy the communication device; and
a re-direction of the call to a remediation center, the remediation center configured to remedy the communication device.
